(19) United States
(12) Patent Application Publication
(10) Pub. No.: US 2026/0180623 A1
(43) Pub. Date: Jun. 25, 2026

(54) METHOD AND APPARATUS FOR ACQUIRING BEAM BOOK FOR RIS CONTROL IN WIRELESS COMMUNICATION SYSTEM

(71) Applicant: Samsung Electronics Co., Ltd., Gyeonggi-do (KR)

(72) Inventors: Wonjun KIM, Gyeonggi-do (KR); Huiwon KIM, Gyeonggi-do (KR); Seunghyun LEE, Gyeonggi-do (KR); Juho LEE, Gyeonggi-do (KR); Jungsoo JUNG, Gyeonggi-do (KR)

(21) Appl. No.: 19/102,568

(22) PCT Filed: Apr. 27, 2023
(86) PCT No.: PCT/KR2023/005817

§ 371 Date: Feb. 10, 2025

(30) Foreign Application Priority Data
Aug. 9, 2022 (KR) 10-2022-0099427

(51) Int. Cl. H04B 7/04; H04B 7/06

(52) U.S. Cl. CPC H04B 7/04013; H04B 7/0626; H04B 7/06952

(57) ABSTRACT

Provided is a 5^{th} generation (5G) or 6^{th} generation (6G) communication system for supporting higher data rates after a 4^{th} generation (4G) communication system such as long term evolution (LTE). According to an embodiment of the present disclosure, a method of generating a beam book for controlling a beam when a beam transmitted from a base station (BS) is reflected by a reconfigurable intelligent surface (RIS) and transmitted to a user equipment (UE) is provided. The method may include receiving information about an RIS identity (ID) from an RIS control unit (RCU), which is a communication entity that controls an RIS that reflects a beam transmitted from the BS and transmits the reflected beam to a UE, identifying an angle of incidence to the RIS from the BS corresponding to the RIS ID, based on the information about the RIS ID, and determining beam-related information used to scan a preset area, based on the identified angle of incidence, wherein a beam book for RIS control in the RCU is obtained based on the identified angle of incidence and the determined beam-related information.

### TECHNICAL FIELD

The present disclosure relates to a wireless communication system, and more particularly, to a method and apparatus for generating a beam book for controlling a beam transmitted from a base station (BS).

### BACKGROUND ART

Considering the development of wireless communication from generation to generation, technologies have been developed mainly for services targeting humans, such as voice calls, multimedia services, and data services. Connected devices which are on an explosive rise after the commercialization of 5^{th} generation (5G) communication systems are expected to be connected to communication networks. Examples of things connected to networks may include vehicles, robots, drones, home appliances, displays, smart sensors installed in various infrastructures, construction machinery, and factory equipment. Mobile devices are expected to evolve in various form factors such as augmented reality glasses, virtual reality headsets, and holographic devices. In the 6^{th} generation (6G) era, efforts are being made to develop improved 6G communication systems, in order to provide various services by connecting hundreds of billions of devices and things. For this reason, 6G communication systems are called beyond 5G systems.

In 6G communication systems predicted to be realized around 2030, a peak data rate is 1 tera (i.e., 1,000 giga) bps, and a wireless latency time is 100 microseconds (psec). That is, a data rate in 6G communication systems is 50 times higher than that in 5G communication systems, and a wireless latency time is reduced to 1/10.

In order to achieve such a high data rate and an ultra-low latency time, it is considered to implement 6G communication systems in a terahertz band (e.g., 95 gigahertz (GHz) to 3 terahertz (THz) bands). It is expected that, due to severer path loss and atmospheric absorption in terahertz bands than those in mmWave bands introduced in 5G, technologies capable of ensuring the signal transmission distance (i.e., coverage) will become more crucial. It is necessary to develop, as major technologies for ensuring the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, high dimensional spatial multiplexing using orbital angular momentum (OAM), and reconfigurable intelligent surface (RIS).

Also, in order to improve frequency efficiency and system network performance, the following technologies have been developed for 6G communication systems: full-duplex technology for enabling an uplink transmission and a downlink transmission to simultaneously use the same frequency resource at the same time, network technology for utilizing satellites, high-altitude platform stations (HAPS), and the like in an integrated manner, an improved network structure for supporting mobile base stations and the like and enabling network operation optimization and automation and the like, dynamic spectrum sharing technology via collision avoidance based on a prediction of spectrum usage, artificial intelligence (AI)-based communication technology for system optimization by utilizing AI from a designing phase and internalizing end-to-end AI support functions, and next-generation distributed computing technology for providing services of complexity beyond the limit of user equipment (UE) computing ability through super-high-performance communication and computing resources (such as mobile edge computing (MEC), clouds, and the like). In addition, through designing new protocols to be used in 6G communication systems, developing mechanisms for implementing a hardware-based security environment and safe use of data, and developing technologies for maintaining privacy, attempts to strengthen connectivity between devices, optimize a network, promote softwarization of network entities, and increase the openness of wireless communication are continuing.

It is expected that research and development of 6G communication systems in hyper-connectivity, including person to machine as well as machine to machine will allow the next hyper-connected experience. Particularly, it is expected that services such as truly immersive extended reality (XR), high-fidelity mobile hologram, and digital replica could be provided through 6G communication systems. Also, services such as remote surgery for security and reliability enhancement, industrial automation, and emergency response will be provided through 6G communication systems and applied in various fields such as industry, medical care, automobiles, and home appliances.

### DISCLOSURE

### Technical Problem

A disclosed embodiment may provide a method and apparatus for generating a beam book for controlling a beam when the beam transmitted from a base station (BS) is reflected by a reconfigurable intelligent surface (RIS) and transmitted to a user equipment (UE) in a wireless communication system.

### Technical Solution

In an embodiment of the present disclosure, a method by which a base station (BS) performs communication in a wireless communication system may include receiving information about a reconfigurable intelligent surface (RIS) identity (ID) from an RIS control unit (RCU), which is a communication entity that controls an RIS that reflects a beam transmitted from the BS and transmits the reflected beam to a user equipment (UE). The method may include identifying an angle of incidence to the RIS from the BS corresponding to the RIS ID, based on the information about the RIS ID. The method may include determining beam-related information used to scan a preset area, based on the identified angle of incidence, wherein a beam book for RIS control in the RCU is obtained based on the identified angle of incidence and the determined beam-related information.

In an embodiment of the present disclosure, a base station (BS) for performing communication in a wireless communication system, the BS may include a transceiver, and at least one processor connected to the transceiver. In an embodiment of the present disclosure, the at least one processor may be configured to receive information about a reconfigurable intelligent surface (RIS) identity (ID) from an RIS control unit (RCU), which is a communication entity that controls an RIS that reflects a beam transmitted from the BS and transmits the reflected beam to a user equipment (UE), identify an angle of incidence to the RIS from the BS corresponding to the RIS ID, based on the information about the RIS ID, and determine beam-related information used to scan a preset area, based on the identified angle of incidence, wherein a beam book for RIS control in the RCU is obtained based on the identified angle of incidence and the determined beam-related information.

In an embodiment of the present disclosure, a computer-readable recording medium having recorded thereon a program for executing the method on a computer may be provided.

### DESCRIPTION OF DRAWINGS

FIG. 1 is a diagram for describing a method of performing beam transmission using a reconfigurable intelligent surface (RIS), according to an embodiment.

FIG. 2 is a flowchart for describing a method of generating a beam book, according to an embodiment.

FIG. 3 is a flowchart for describing a method by which an RIS control unit (RCU) generates a beam book, according to an embodiment.

FIG. 4 is a flowchart for describing a method by which a base station (BS) generates a beam book, according to an embodiment.

FIG. 5 is a flowchart for describing a method by which an RCU generates a beam book when an angle of incidence is variable, according to an embodiment.

FIG. 6 is a flowchart for describing a method by which a BS generates a beam book when an angle of incidence is variable, according to an embodiment.

FIG. 7 is a flowchart for describing an embodiment of generating a beam book by reflecting a scan range, according to an embodiment.

FIG. 8 is a diagram for describing a beam transmission path using an RIS, according to an embodiment.

FIGS. 9A and 9B are diagrams for describing a system that supports multiple areas by using a beam book, according to an embodiment.

FIGS. 10A and 10B are diagrams for describing a system using a plurality of RISs, according to an embodiment.

FIGS. 11A and 11B are diagrams for describing a system using a plurality of BSs, according to an embodiment.

FIG. 12 is a diagram for describing an example of a pre-determined beam book, according to an embodiment.

FIG. 13 is a diagram for describing a scan range, according to an embodiment.

FIG. 14 is a diagram for describing a method of estimating an angle of incidence, according to an embodiment.

FIG. 15 is a block diagram schematically illustrating a configuration of a BS, according to an embodiment.

FIG. 16 is a block diagram schematically illustrating a configuration of an RCU, according to an embodiment.

### MODE FOR INVENTION

Embodiments of the present disclosure will now be described more fully with reference to the accompanying drawings.

As the present disclosure allows for various changes and numerous examples, particular embodiments of the present disclosure will be illustrated in the drawings and described in detail in the written description. However, this is not intended to limit the present disclosure to particular modes of practice, and it will be understood that all changes, equivalents, and substitutes that do not depart from the spirit and technical scope of various embodiments are encompassed in the present disclosure.

In the description of embodiments, certain detailed explanations of related art are omitted when it is deemed that they may unnecessarily obscure the essence of the present disclosure. Also, numbers (e.g., first and second) used in the description of the specification are merely identifier codes for distinguishing one element from another.

The terms used herein are those general terms currently widely used in the art in consideration of functions in the present disclosure but the terms may vary according to the intention of one of ordinary skill in the art, precedents, or new technology in the art. Also, some of the terms used herein may be arbitrarily chosen by the present applicant, and in this case, these terms are defined in detail below. Accordingly, the specific terms used herein should be defined based on the unique meanings thereof and the whole context of the present disclosure.

The scope of the present disclosure may be defined by the claims described below rather than the detailed description. Various features included only in one claim category (e.g., method claim) of the present disclosure may be claimed in other claim categories (e.g., system claim). Also, an embodiment of the present disclosure may include not only a combination of features specified in the appended claims but also various combinations of individual features within the claims. The scope of the present disclosure is defined by the following claims, and it is intended that the present disclosure cover modifications or variations of the present disclosure provided they come within the scope of the appended claims and their equivalents.

Also, in the present disclosure, it will be understood that when elements are “connected” or “coupled” to each other, the elements may be directly connected or coupled to each other, but may alternatively be connected or coupled to each other with an intervening element therebetween, unless specified otherwise. Also, an element is referred to as being “connected” to another element, it will be understood to include that the element is “directly connected” or “physically connected” to the other element or is “electrically connected” to the other element with another element therebetween. The terms “transmit,” “receive,” and “communicate” encompass both direct and indirect communication.

When a part “includes” an element in the present disclosure, another element may be further included, rather than excluding the existence of the other element, unless otherwise described.

Also, in the present disclosure, regarding an element represented as a ‘ . . . unit’ or a ‘module’, two or more elements may be combined into one element or one element may be divided into two or more elements according to subdivided functions. These functions may be implemented as hardware, software, or a combination of hardware and software. In addition, each element described hereinafter may additionally perform some or all of functions performed by another element, in addition to main functions of itself, and some of the main functions of each element may be performed entirely by another element.

The singular forms “a,” “an,” and “the” are intended to include the plural forms as well, unless the context clearly indicates otherwise. The terms used herein, including technical or scientific terms, may have the same meaning as commonly understood by one of ordinary skill in the art described in the present disclosure.

Throughout the present disclosure, “or” is inclusive and not exclusive, unless otherwise described. Accordingly, unless clearly indicated otherwise or the context indicates otherwise, the expression “A or B” may include A, may include B, or may include both A and B. In the present disclosure, the phrase “at least one of” or “one or more”, when used with a list of items, means that different combinations of one or more of the listed items may be used or that only one item in the list may be needed. For example, “at least one of A, B, and C” may include any of the following combinations: A, B, C, A and B, A and C, B and C, or A and B and C.

It will be understood that each block of flowchart illustrations and combinations of blocks in the flowchart illustrations may be implemented by computer program instructions. Because these computer program instructions may be loaded into a processor of a general-purpose computer, special purpose computer, or other programmable data processing equipment, the instructions, which are executed via the processor of the computer or other programmable data processing equipment generate means for performing the functions specified in the flowchart block(s). Because these computer program instructions may also be stored in a computer-executable or computer-readable memory that may direct the computer or other programmable data processing equipment to function in a particular manner, the instructions stored in the computer-executable or computer-readable memory may produce an article of manufacture including instruction means for performing the functions stored in the flowchart block(s). Because the computer program instructions may also be loaded into a computer or other programmable data processing equipment, a series of operational steps may be performed on the computer or other programmable data processing equipment to produce a computer implemented process, and thus, the instructions executed on the computer or other programmable data processing equipment may provide steps for implementing the functions specified in the flowchart block(s).

Also, each block may represent a module, segment, or portion of code, which includes one or more executable instructions for implementing specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Hereinafter, an embodiment of the present disclosure will be described in detail with reference to the accompanying drawings so that one of ordinary skill in the art may easily implement the present disclosure. However, the present disclosure may be implemented in various different forms and is not limited to the embodiments described herein. Also, in the drawings, parts irrelevant to the description are omitted in order to clearly describe the present disclosure, and like reference numerals designate like elements throughout the specification.

In addition, hereinafter, a long term evolution (LTE), LTE-advanced (LTE-A), or 5^{th} generation (5G) system may be described as an example, but an embodiment of the present disclosure may be also applied to other communication systems having a similar technical background or channel type. For example, the other communication systems may include a 5G-advance or 6^{th} generation mobile communication technology (6G) developed after 5G mobile communication technology (or new radio (NR)), and 5G described below may be a concept including a conventional LTE and LTE-A and other services similar thereto. Also, the present disclosure may be applied to other communication systems through some modifications without departing from the scope of the present disclosure at the discretion of one of ordinary skill in the art.

The terms used herein will be briefly described, and an embodiment of the present disclosure will be described in detail.

The terms used herein are those defined in consideration of functions in the present disclosure, but the terms may vary according to the intention of users or operators, precedents, etc. Hence, the terms used herein should be defined based on the meaning of the terms together with the descriptions throughout the specification.

In the present disclosure, a base station (BS) is a subject configured to perform resource allocation to a user equipment (UE), and may be at least one of, but not limited to, a gNode B, an eNode B, a Node B, (or xNode B (x is a character including “g” and “e”)), a base station (BS), a wireless access unit, a BS controller, a satellite, an air-born vehicle, or a node on a network. A BS in the present disclosure may refer to a BS itself, a cell, or a radio unit (RU) according to interpretation, and a target for exchanging a message with a UE may be a distributed unit (DU) or a centralized unit (CU) depending on its structure.

Also, in the present disclosure, a user equipment (UE) may include a mobile station (MS), a cellular phone, a smartphone, a computer, a vehicle, a satellite, or a multimedia system capable of performing a communication function.

Hereinbelow, terms indicating broadcast information, terms indicating control information, terms related to communication coverage, terms indicating a change in a state (e.g., an event), terms indicating network entities, terms indicating messages, and terms indicating components of an apparatus are exemplified for convenience of explanation. Accordingly, the present disclosure is not limited to the terms described below, and other terms that refer to objects having equivalent technical meanings may be used.

For convenience of explanation below, the terms and names defined in LTE and NR standards, which are the latest standards defined by the 3^{rd} generation partnership projection (3GPP) organizations among currently existing communication standards, are used. However, the present disclosure is not limited to the terms and names, and may also be applied to systems following other standards.

With the development of mobile communication technology, new methods for efficiently transmitting a beam transmitted from a base station (BS) to a user equipment (UE) are being proposed. As it is considered to implement 6G in terahertz bands, coverage problems due to severer path loss and atmospheric absorption than those in mmWave bands of 5G may occur. Accordingly, a reconfigurable intelligent surface (RIS) that is one of the proposed technologies may expand a range of an area that a single BS may cover by reflecting a beam and transmitting data to a UE in a shadow area. Also, the RIS may prevent data loss caused by beam blocking due to obstacles such as buildings existing between the UE and the BS.

A beam book for existing analog beamforming may be set by considering only an angle of departure (AoD) because there is only a single path from a BS to a UE. For example, the BS may set a beam book including 56 beams by adjusting an AoD at 6° intervals, and the UE may set a beam book including 14 beams by adjusting an AoD by using 7 azimuth and 2 zenith angles. However, during beam transmission using an RIS, there are two paths from a BS to a UE. Accordingly, there is a demand for the introduction of a new beam book for RIS control.

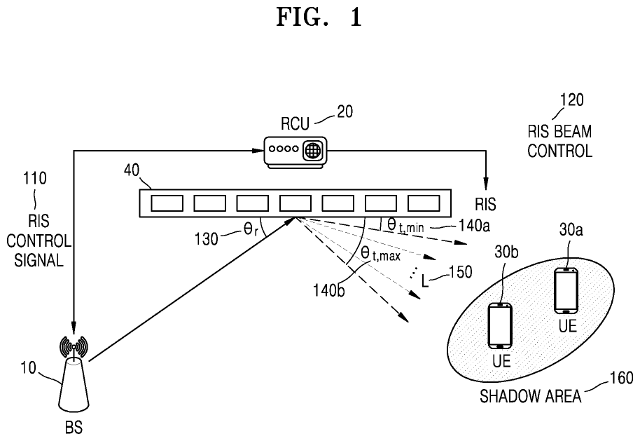

FIG. 1 is a diagram for describing a method of performing beam transmission using an RIS, according to an embodiment.

Referring to FIG. 1, a wireless communication system for performing a beam transmission method using an RIS according to an embodiment may include, but is not limited to, a BS 10, an RIS control unit (RCU) 20, at least one UE 30 (e.g., 30a and 30b), and an RIS 40. Although an apparatus for controlling an RIS through signal transmission/reception to/from a BS is an RCU in the present disclosure, this is only an example for convenience of explanation and the apparatus for controlling an RIS according to the present disclosure is not limited to the RCU.

The RCU 20 is a unit for controlling the RIS 40, and may transmit and receive a signal 110 for controlling the RIS 40 to and from the BS 10 and may transmit a signal 120 for RIS control to the RIS 40. The RCU 20 may control one RCU 40 or may control a plurality of RCUs. The RCU 20 may perform wireless communication with one BS 10 or may perform wireless communication with a plurality of BSs.

The RIS 40 controlled by the RCU 20 may reflect a beam transmitted from the BS 10 and may transmit the reflected beam to the UE 30 located in a shadow area. In the present disclosure, an angle formed by the beam transmitted from the BS 10 with the RIS 40 is referred to as an angle of incidence (θᵣ) 130. Also, an angle formed by the beam transmitted from the BS 10 and reflected by the RIS 40 with the UE 30 is referred to as an angle of reflection (θₗ) 140. The angle of incidence 130 may be identified by the BS 10 or the RCU 20 or may be estimated by the RCU 20.

In order to transmit a beam from the BS 10 to the UE 30, the BS 10 and the RCU 20 may obtain a beam book for controlling the RIS 40. The RIS 40 may include a plurality of elements, and the beam book may include beam information corresponding to each element. The beam book may be generated based on the angle of incidence 130 and beam-related information determined by the BS 10 according to a system operation purpose. In the present disclosure, the beam-related information may include a scan range and beam operation information.

The scan range refers to an area that the BS 10 is to search in the shadow area 160 according to the system operation purpose. In an embodiment of the present disclosure, the scan range may be indicated through angle information of the angle of reflection 140. For example, the scan range may be indicated by using a minimum value (θ_{t,min}) 140a of the angle of reflection and a maximum value (θ_{t,max}) 140b of the angle of reflection (e.g. θ_{t,min} to θ_{t,max}) or may be indicated by a specific value (e.g. −10° to 10°). The angle of reflection 140 may be determined according to capability of the RIS 40. The capability of the RIS 40 may include, but is not limited to, hardware characteristics of the RIS 40 and the number of phase shift bits. In an embodiment of the present disclosure, the scan range may be indicated in the form of a flag signal.

The beam operation information may be determined according to an operation purpose of the BS 10. In the present disclosure, the beam operation information may include, but is not limited to, the number of beams, a band width, and a beam spacing. The beam operation information may be determined by considering the scan range and the angle of incidence 130.

In an embodiment of the present disclosure, the BS 10 may generate a beam book based on the identified angle of incidence 130 and the determined beam-related information. The BS 10 may generate a beam book by reflecting information about the hardware characteristics of the RIS 40 received from the RCU 20. In an embodiment of the present disclosure, the BS 10 may transmit the identified angle of incidence 130 and the determined beam-related information to the RCU 20, and the RCU 20 may generate a beam book based on the received information. The RCU 20 may generate a beam book by reflecting information about the hardware characteristics of the RIS 40.

In an embodiment of the present disclosure, the angle of incidence 130 may be variable. When the angle of incidence 130 is variable, it may include a case where the BS 10 has mobility or the RIS 40 has mobility or rotationality. Also, when the angle of incidence 130 is variable, it may include a case where an angle of the BS 10 or the RIS 40 changes due to weather effects. When the angle of incidence 130 between the BS 10 and the RIS 40 changes, the BS 10 or the RCU 20 may estimate the angle of incidence 130. For example, the BS 10 or the RCU 20 may estimate the angle of incidence 130 by using a channel estimated through a channel state information reference signal (CSI-RS) or by using beam sweeping or an angle of arrival (AOA) estimation algorithm. When the angle of incidence 130 is estimated, it is assumed that boresight values of the RIS 40 and the RCU 20 are the same.

The UE 30 may receive a beam transmitted from the BS 10 by using the RIS 40. In an embodiment of the present disclosure, the UE 30 may measure reference signal received power (RSRP) of the received signal to obtain an RSRP measurement value and may transmit the RSRP measurement value to the BS 10. The BS 10 may set a specific area to be scanned based on the RSRP measurement value. In an embodiment of the present disclosure, the wireless communication system for performing a beam transmission method using an RIS may include a plurality of UEs 30. The plurality of UEs 30 may share one RIS 40.

In an embodiment of the present disclosure, in the wireless communication system for performing a beam transmission method using an RIS, the BS 10 may perform a scan on a plurality of areas. The BS 10 may differently set beam-related information for each of the plurality of areas according to the operation purpose. In an embodiment of the present disclosure, the BS 10 may perform a scan on an entire scan area according to the capability of the RIS 40, and may perform a scan on a specific area where the UE 30 exists.

In an embodiment of the present disclosure, the wireless communication system for performing a beam transmission method using an RIS may include a plurality of RISs. When there are a plurality of RISs, the angle of incidence 130 formed with the BS 10 may be different for each RIS, and the BS 10 may differently set the number of beams and a beam width for each RIS according to the operation purpose. The BS 10 may select the RIS 40 to be used from among the plurality of RISs, and the RCU 20 may identify an ID of the RIS 20 to be used and may transmit the ID of the RIS 20 to the BS 10. In order to perform beam sweeping by using another RIS different from a currently used RIS, the BS 10 and the RCU 20 may perform switching to a beam book obtained for the other RIS. The plurality of RISs may be controlled by one RCU 20 or may each be controlled by an individual RCU 20.

In an embodiment of the present disclosure, the wireless communication system for performing a beam transmission method using an RIS may include a plurality of BSs. The plurality of BSs may operate the system by sharing one RIS 40. As a position of each BS is different, the angle of incidence 130 may be differently identified and a range to be scanned by each BS and beam operation information may be differently set.

A process of obtaining a beam book for RIS operation between the BS 10 and the RCU 20 will be described in detail in the following flowchart.

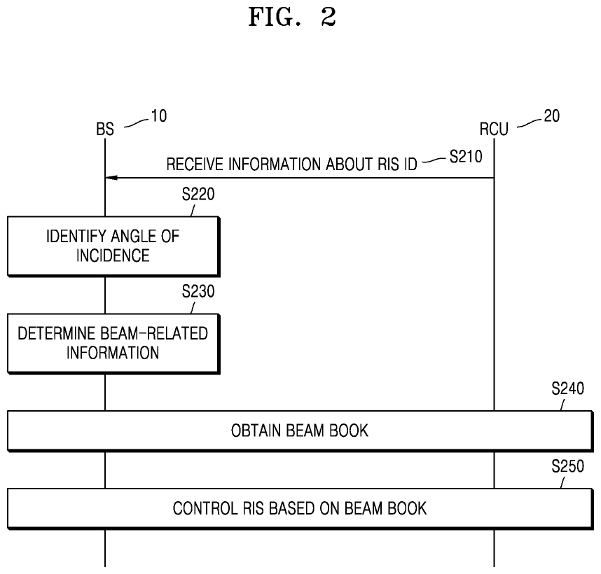

FIG. 2 is a flowchart for describing a method of generating a beam book, according to an embodiment.

In operation S210, the BS 10 may receive information about an RIS ID from the RCU 20. Hereinafter, for convenience of explanation, the information about the RIS ID is referred to as the RIS ID. The RIS ID is an identifier indicating an RIS to be used by the RCU 20. The RCU 20 may determine the RIS to be used according to a beam purpose and may identify an RIS ID corresponding to the RIS.

In operation S220, the BS 10 may identify an angle of incidence.

The angle of incidence is an angle formed by a beam transmitted from the BS 10 with the RIS and refers to an angle of departure (AoD). In an embodiment of the present disclosure, when a position of the BS 10 and the RIS to be used are determined, the angle of incidence may correspond to the RIS ID. For example, when the BS 10 and the RIS are fixed, the BS 10 receiving the information about the RIS ID may identify an angle of incidence mapped in a one-to-one manner to the RIS. In an embodiment of the present disclosure, when the RCU 20 is an entity registered in a wireless communication system, the BS 10 may receive the information about the RIS ID and information about the angle of incidence through system information provided in an initial access procedure. In this case, operations S210 and S220 may be omitted.

In operation S230, the BS 10 may determine beam-related information. The beam-related information may include information about a scan range through reflection of a beam by the RIS. Hereinafter, the scan range through reflection of the beam by the RIS is referred to the scan range of the beam for convenience of explanation. Also, the beam-related information may include beam operation information. The beam-related information may be determined based on the angle of incidence identified by the BS 10. For example, when the angle of incidence is 30°, the scan range may be determined to −60° to 60° at the maximum. The number of beams to be used, a beam width, and a beam spacing may be determined according to the scan range.

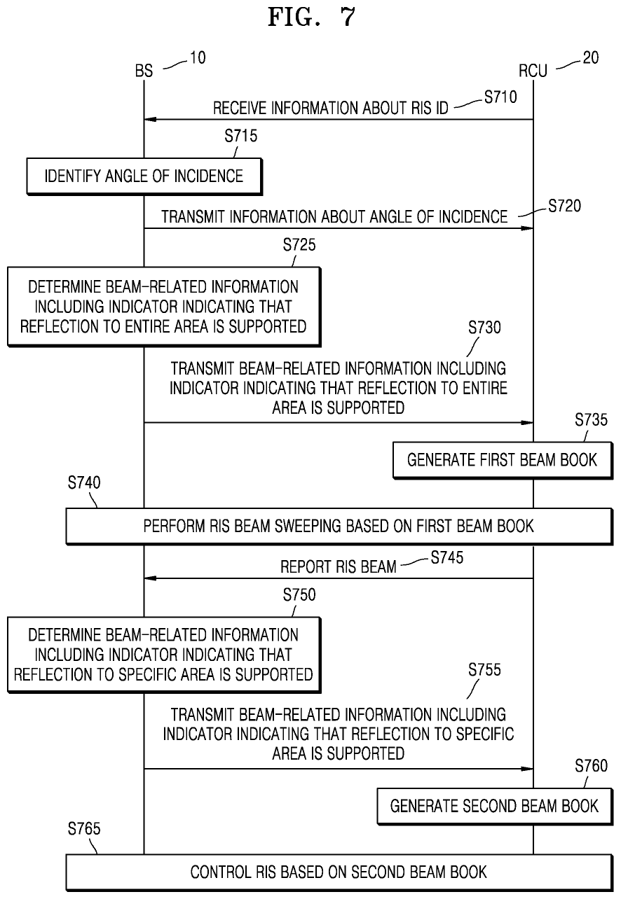

In an embodiment of the present disclosure, the scan range of the beam may include an entire scan area or a specific area in the entire area according to capability of the RIS. Hereinafter, for convenience of explanation, the entire scan area is referred to as a global scan range, and the specific area in the entire area is referred to as a local scan area. The global scan range may be determined according to the capability of the RIS. The capability of the RIS may include, but is not limited to, hardware characteristics of the RIS and the number of phase shift bits. In an embodiment of the present disclosure, it may be checked whether there is a UE in a shadow area, by using the global scan range. The local scan range may be used when a scan is required for a surrounding area of the UE determined to be located in the shadow area. In an embodiment of the present disclosure, the local scan range may be determined through a beam sweeping result based on a beam book generated according to the global scan range. For example, according to a global scan, an area corresponding to a preset angle range (e.g. −20′ to 20°) based on a beam with highest reference signal received power (RSRP) or beams with RSRP higher than a preset reference value may be set as the local scan range. In an embodiment of the present disclosure, the BS 10 and the RCU 20 may obtain a first beam book according to the global scan range and a second beam book according to the local scan range, which will be described below in detail with reference to FIG. 7.

In an embodiment of the present disclosure, the scan range of the beam may be indicated through angle information of an angle of reflection or a flag signal. An angle of arrival (AoA) that is an angle of the beam reflected by the RIS is referred to as an angle of reflection (θᵢ) 140. The scan range of the beam may be indicated through angle information such as a minimum angle of reflection (θ_{t,min}) to a maximum angle of reflection (θ_{t,max}) (e.g. −60° to 60°) based on the angle of reflection (θᵣ). When the RCU 20 knows a plurality of scan ranges in advance, the scan range of the beam may be determined in the form of a flag signal indicating the scan ranges. For example, when ‘global scan range=1’ is set, a scan of the entire area may be indicated with ‘1’.

In an embodiment of the present disclosure, the beam operation information may include at least one of the number of beams to be operated, a beam width, or a beam spacing. The number of beams to be operated may refer to the number of beams set by the BS in consideration of synchronization signal broadcast block (SSB) resources. In an embodiment of the present disclosure, the number of beams to be operated may be indicated in the form of an integer. The beam width refers to a width of the beam reflected by the RIS. In an embodiment of the present disclosure, when the beam width is pre-defined, the BS 10 may indicate the beam width through an index. The BS 10 may indicate the beam width according to the beam purpose. For example, the BS 10 may narrow the beam width in order to increase an SINR according to the beam purpose. The beam spacing may be set according to the scan range of the beam and the number of beams. In an embodiment of the present disclosure, the beam spacing may be set to be uniform, or may be set to be non-uniform by the BS 10.

In an embodiment of the present disclosure, information about the identified angle of incidence and the determined beam-related information may be transmitted to the RCU 20. In an embodiment of the present disclosure, the information about the identified angle of incidence may be transmitted together with the determined beam-related information or may be transmitted separately.

In operation S240, the BS 10 or the RCU 20 may obtain a beam book based on the identified angle of incidence and the determined beam-related information. The beam book may include information about a beam reflected to the UE by considering two paths by the RIS and reflecting the beam-related information such as the scan range and the number of beams.

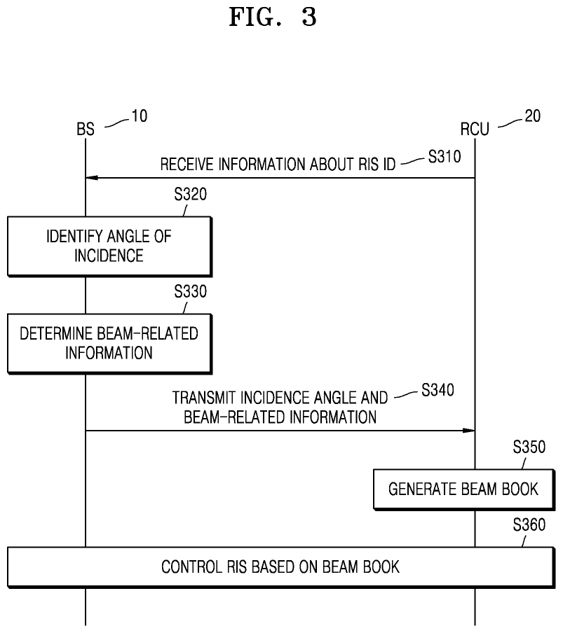

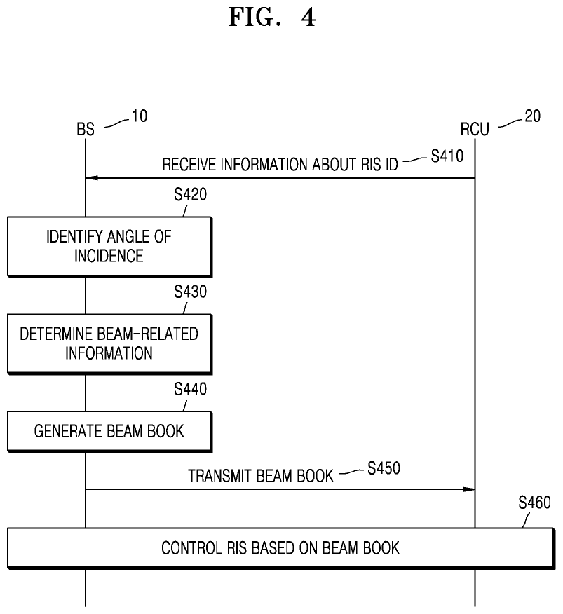

In an embodiment of the present disclosure, the beam book may be generated by the RCU 20 receiving the information about the identified angle of incidence and the determined beam-related information. In an embodiment of the present disclosure, the beam book may be generated by the BS 10 based on the identified angle of incidence and the determined beam-related information. The beam book generated by the BS 10 may be transmitted to the RCU 20, which will be described below in detail with reference to FIGS. 3 and 4.

In operation S250, the BS 10 and the RCU 20 may control the RIS based on the obtained beam book. The BS 10 and the RCU 20 may transmit and receive a signal for controlling the RIS, and the RCU 20 may transmit the signal for controlling the RIS to the RIS based on the obtained beam book.

FIG. 3 is a flowchart for describing a method by which an RCU generates a beam book, according to an embodiment. Hereinafter, a detailed description of operations that are the same as those in FIG. 2 will be omitted.

Referring to FIG. 3, the RCU 20 receiving an identified angle of incidence and determined beam-related information may generate a beam book.

In operation S310, the BS 10 may receive information about an RIS ID from the RCU 20. The RIS ID is an identifier indicating an RIS to be used by the RCU 20. The RCU 20 may determine the RIS to be used according to a beam purpose and may identify an RIS ID corresponding to the RIS.

In operation S320, the BS 10 may identify an angle of incidence.

The angle of incidence is an angle formed by a beam transmitted from the BS 10 with the RIS and refers to an angle of departure (AoD). In an embodiment of the present disclosure, the angle of incidence may correspond to the RIS ID. For example, when the BS 10 and the RIS are fixed, the BS 10 receiving the information about the RIS ID may identify an angle of incidence corresponding in a one-to-one manner to the RIS. In an embodiment of the present disclosure, when the RCU 20 itself is an entity registered in a wireless communication system, the BS 10 may receive information about the RIS and the RCU 20.

In operation S330, the BS 10 may determine beam-related information. The beam-related information may include information about a scan range through reflection of a beam by the RIS. Also, the beam-related information may include beam operation information. The beam-related information may be determined based on the identified angle of incidence.

In operation S340, the BS 10 may transmit information about the angle of incidence and the beam-related information to the RCU 20. In detail, the BS 10 may transmit the information about the angle of incidence identified in operation S320 and the beam-related information determined in operation S330.

In an embodiment of the present disclosure, the information about the identified angle of incidence and the determined beam-related information may be transmitted together from the BS 10 to the RCU 20. In an embodiment of the present disclosure, the information about the identified angle of incidence and the determined beam-related information may be individually transmitted from the BS 10 to the RCU 20. In an embodiment of the present disclosure, the information about the identified angle of incidence may be transmitted from the BS 10 to the RCU 20 before the beam-related information is determined.

In operation S350, the RCU 20 may generate a beam book. The beam book may be generated based on the identified angle of incidence and the determined beam-related information received from the BS 10.

The beam book generated by the RCU 20 may reflect hardware characteristics of the RIS. For example, the hardware characteristics of the RIS may include at least one of a size of the RIS, an RIS unit cell pattern, an RIS unit cell phase error, specular reflection loss, or unit cell reflection loss.

In an embodiment of the present disclosure, when there a plurality of scan ranges to be searched by the BS 10, a plurality of beam books for the plurality of scan ranges may be generated. For example, when a first beam book for a first area and a second beam book for a second area are generated, the first beam book may include information about 6 beams based on a global scan range (e.g. −60° to 60°), and the second beam book may include information about 4 beams based on a local scan range (e.g., −10° to 10° based on a beam with highest RSRP).

In operation S360, the BS 10 and the RCU 20 may control the RIS based on the beam book. The BS 10 and the RCU 20 may receive a signal for controlling the RCU, and the RCU 20 may transmit the signal for controlling the RIS to the RIS based on the obtained beam book. The RCU 20 may perform efficient RIS control through the beam book generated by reflecting the hardware characteristics of the RIS.

FIG. 4 is a flowchart for describing a method by which a BS generates a beam book, according to an embodiment. Hereinafter, a detailed description of operations that are the same as those in FIG. 2 will be omitted.

Referring to FIG. 4, the BS 10 may generate a beam book based on an identified angle of incidence and determined beam-related information.

In operation S410, the BS 10 may receive information about an RIS ID from the RCU 20. The RIS ID is an identifier indicating an RIS to be used by the RCU 20. The RCU 20 may determine the RIS to be used according to a beam purpose and may identify an RIS ID corresponding to the RIS.

In operation S420, the BS 10 may identify an angle of incidence.

The angle of incidence is an angle formed by a beam transmitted from the BS 10 with the RIS and refers to an angle of departure (AoD). In an embodiment of the present disclosure, the angle of incidence may correspond to the RIS ID. When the BS 10 and the RIS are fixed, the BS 10 receiving the information about the RIS ID may identify an angle of incidence.

In operation S430, the BS 10 may determine beam-related information. The beam-related information may include information about a scan range through reflection of a beam by the RIS. Also, the beam-related information may include beam operation information. The beam-related information may be determined based on the identified angle of incidence.

In operation S440, the BS 10 may generate a beam book. The beam book may be generated based on the identified angle of incidence and the determined beam-related information. In an embodiment of the present disclosure, when there are a plurality of scan ranges to be searched by the BS 10, a plurality of beam books may be generated for the plurality of scan ranges. In an embodiment of the present disclosure, the BS 10 may receive information about hardware characteristics of the RIS from the RCU 20 and may generate a beam book by reflecting the information about the hardware characteristics of the RIS.

In operation S450, the BS 10 may transmit the beam book to the RCU 20. The beam book generated by the BS 10 may be transmitted to the RCU 20 to control the RIS. The BS 10 may transmit and receive an RIS control signal to and from the RCU 20 to control the RIS. In an embodiment of the present disclosure, the beam book may be transmitted through at least one of the RIS control signal or MAC-CE.

In operation S460, the BS 10 and the RCU 20 may control the RIS based on the beam book. The BS 10 and the RCU 20 may transmit and receive a signal for controlling the RIS, and the RCU 20 may transmit the signal for controlling the RIS based on the obtained beam book.

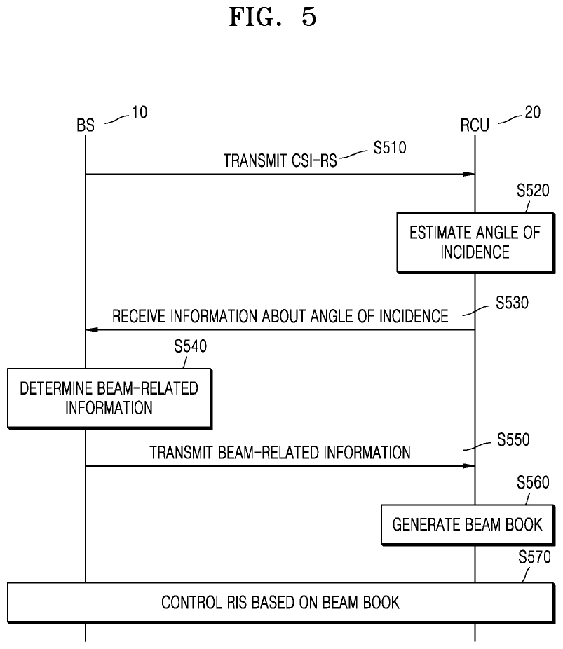

FIG. 5 is a flowchart for describing a method by which an RCU generates a beam book when an angle of incidence is variable, according to an embodiment. Hereinafter, a detailed description of operations that are the same as those in FIGS. 2 and 3 will be omitted.

Referring to FIG. 5, when an angle of incidence is variable, the angle of incidence may be estimated and identified, and the RCU may generate a beam book based on the identified angle of incidence and determined beam-related information. When the angle of incidence is variable, it may include, but is not limited to a case where the BS 10 has mobility or an RIS has mobility or rotationality, or a case where an angle of the BS 10 or the RIS changes due to weather effects, etc.

In operation S510, the BS 10 may transmit a channel state information reference signal (CSI-RS) to the RCU 20. When an angle of incidence is variable, the CSI-RS is a reference signal for estimating the angle of incidence through channel estimation.

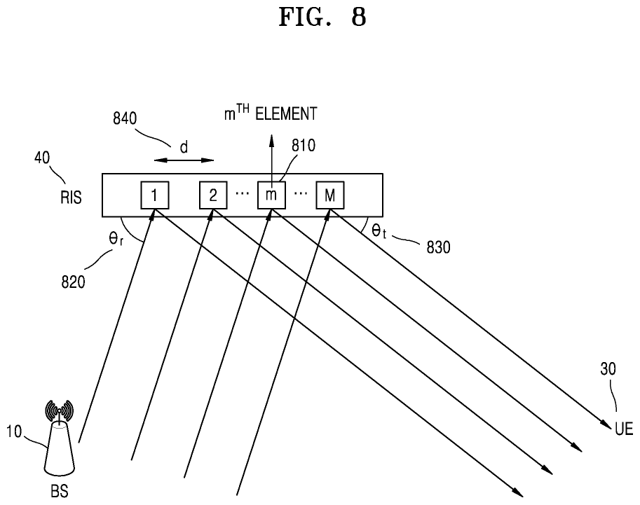

The CSI-RS is a reference signal for estimating a channel through which the BS 10 transmits a downlink. The RCU 20 may estimate a channel between the BS 10 and the RCU 20 based on the received CSI-RS. Channel estimation will be described below in detail with reference to FIG. 8.

In an embodiment of the present disclosure, the BS 10 may set an angle of incidence estimation period. The BS 10 may differently set an angle of incidence estimation period according to a system operation purpose. For example, when frequent updates of information are required for a sharp area, the BS 10 perform angle of incidence estimation in a short cycle. In an embodiment of the present disclosure, when the BS 10 or an RIS has mobility or rotationality, the BS 10 may set an angle of incidence estimation period by considering a moving speed or rotation periodicity. For example, when a rotation period is constant at w, the BS 10 may set the same angle of incidence estimation period and may adjust an angle of incidence error due to signal distortion.

In operation S520, the RCU 20 may estimate an angle of incidence. The estimation of the angle of incidence is based on the assumption that boresight values of the RCU 20 and the RIS are the same. Because the boresight values are the same, an angle of incidence between the BS 10 and the RCU 20 and an angle of incidence between the BS 10 and the RIS are the same.

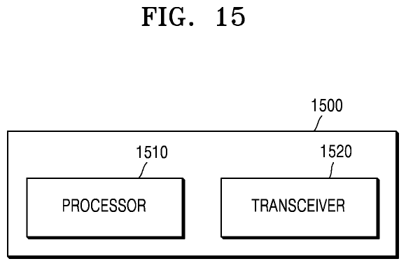

In an embodiment of the present disclosure, the angle of incidence may be estimated by using the channel estimated in operation S510. The RCU 20 may estimate the angle of incidence by using a phase difference between adjacent antennas that may be obtained from the channel estimated through the CSI-RS transmitted to the RCU 20. In an embodiment of the present disclosure, the angle of incidence may be estimated through beam sweeping between the BS 10 and the RCU 20. The BS 10 may transmit beams to angle of incidence candidates to obtain an RSRP value for each beam, and may estimate an angle of a beam with a highest RSRP value as the angle of incidence. In an embodiment of the present disclosure, the angle of incidence may be estimated by using an AOA estimation algorithm through multi-antenna processing. For example, the AOA estimation algorithm may include a multiple signal classification (MUSIC) algorithm and an estimation of signal parameters via rotational invariance technique (ESPRIT) algorithm. A specific method of estimating the angle of incidence will be described below with reference to FIG. 15.

In operation S530, the BS 10 may receive information about the angle of incidence from the RCU 20.

In an embodiment of the present disclosure, the BS 10 may receive information about the angle of incidence identified through the estimation of the angle of incidence performed in operation S520. In an embodiment of the present disclosure, the BS 10 may receive pieces of angle of incidence estimation information estimated to identify the angle of incidence in operation S520. For example, when a CSI-RS is used, channel information may be received; when beam sweeping is used, a measured RSRP value may be received; and when an algorithm is used, a measured power value or information about a direction of arrival (DOA) may be received. The BS 10 may identify the angle of incidence based on the pieces of angle of incidence estimation information received from the RCU 20.

In operation S540, the BS 10 may determine beam-related information. The beam-related information may include information about a scan range of an area that may be scanned by the BS through reflection of a beam by the RIS. Also, the beam-related information may include beam operation information. The beam-related information may be determined based on the identified angle of incidence.

In operation S550, the BS 10 may transmit the beam-related information to the RCU 20. In detail, the BS 10 may transmit the beam-related information determined in operation S540. In an embodiment of the present disclosure, when the identification of the angle of incidence is performed by the BS 10 based on the angle of incidence estimation information, information about the identified angle of incidence may be transmitted together with the determined beam-related information. In an embodiment of the present disclosure, the determined beam-related information and the information about the identified angle of incidence may be individually transmitted.

In operation S560, the RCU 20 may generate a beam book. The beam book may be generated based on the information about the identified angle of incidence and the determined beam-related information received from the BS 10.

The beam book generated by the RCU 20 may reflect hardware characteristics of the RIS. For example, the hardware characteristics of the RIS may include at least one of a size of the RIS, an RIS unit cell pattern, an RIS unit cell phase error, specular reflection loss, or unit cell reflection loss. In an embodiment of the present disclosure, when there are a plurality of scan ranges to be searched by the BS 10, a plurality of beam books may be generated for the plurality of scan ranges.

In operation S570, the BS 10 and the RCU 20 may control the RIS based on the obtained beam book. The BS 10 and the RCU 20 may transmit and receive a signal for controlling the RIS, and the RCU 20 may transmit the signal for controlling the RIS to the RIS based on the obtained beam book. The RCU 20 may perform effective RIS control through the beam book generated by reflecting the hardware characteristics of the RIS.

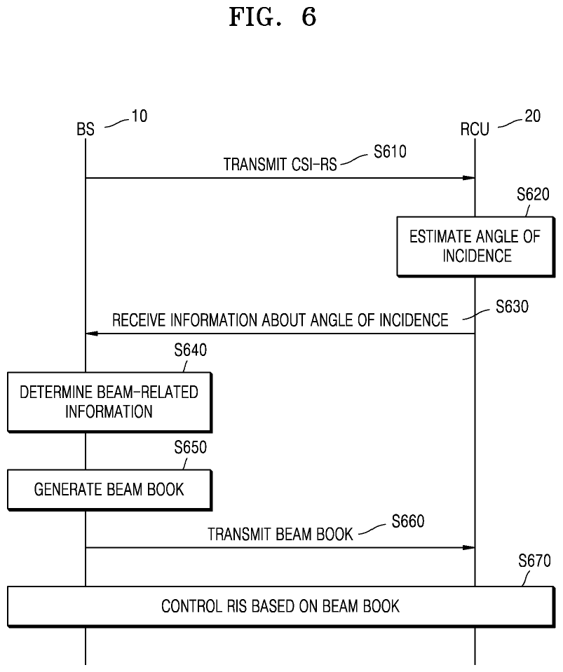

FIG. 6 is a flowchart for describing a method by which a BS generates a beam book when an angle of incidence is variable, according to an embodiment. Hereinafter, a detailed description of operations that are the same as those in FIGS. 2, 4, and 5 will be omitted.

Referring to FIG. 6, when an angle of incidence is variable, the angle of incidence may be estimated and identified, and the BS 10 may generate a beam book based on information about the identified angle of incidence and determined beam-related information.

In operation S610, the BS 10 may transmit a channel state information reference signal (CSI-RS) to the RCU 20. When an angle of incidence is variable, the CSI-RS is a reference signal for estimating the angle of incidence.

The CSI-RS is a reference signal for estimating a channel through which the BS transmits a downlink. The RCU 20 may estimate a channel between the BS 10 and the RCU 20 based on the received CSI-RS. The BS 10 may set an angle of incidence estimation period.

In operation S620, the RCU 20 may estimate an angle of incidence. The estimation of the angle of incidence is based on the assumption that boresight values of the RCU 20 and an RIS are the same. Because the boresight values are the same, an angle of incidence between the BS 10 and the RCU 20 and an angle of incidence between the BS 10 and the RIS are the same. The angle of incidence may be estimated by using the channel estimated through the CSI-RS, or may be estimated by using beam sweeping or an AOA estimation algorithm.

In operation S630, the BS 10 may receive information about the angle of incidence from the RCU 20.

In an embodiment of the present disclosure, the BS 10 may receive information about the angle of incidence identified through the estimation of the angle of incidence performed in operation S620. In an embodiment of the present disclosure, the BS 10 may receive pieces of angle of incidence estimation information estimated to identify the angle of incidence in operation S620. The BS 10 may identify the angle of incidence based on the pieces of angle of incidence estimation information received from the RCU 20.

In operation S640, the BS 10 may determine beam-related information. The beam-related information may include information about a scan range of an area that may be scanned by the BS 10 through reflection of a beam by the RIS. Also, the beam-related information may include beam operation information. The beam-related information may be determined based on the identified angle of incidence.

In operation S650, the BS 10 may generate a beam book. The beam book may be generated based on the identified angle of incidence and the determined beam-related information. In an embodiment of the present disclosure, when there are a plurality of scan ranges to be searched by the BS 10, a plurality of beam books may be generated for the plurality of scan ranges. In an embodiment of the present disclosure, the BS 10 may receive information about hardware characteristics of the RIS from the RCU 20 and may generate a beam book by reflecting the hardware characteristics of the RIS.

In operation S660, the BS 10 may transmit the beam book to the RCU 20. The beam book generated by the BS 10 is transmitted to the RCU 20 to control the RIS. The BS 10 may transmit and receive an RIS control signal to and from the RCU 20 to control the RIS. In an embodiment of the present disclosure, the beam book may be transmitted through at least one of the RIS control signal or MAC-CE.

In operation S670, the BS 10 and the RCU 20 may control the RIS based on the beam book. The BS 10 and the RCU 20 may transmit and receive a signal for controlling the RIS, and the RCU 20 may transmit the signal for controlling the RIS to the RIS based on the obtained beam book.

FIG. 7 is a flowchart for describing an embodiment of generating a beam book by reflecting a scan range, according to an embodiment. Hereinafter, a detailed description of operations that are the same as those in FIG. 2 will be omitted.

Referring to FIG. 7, a beam book may be generated for each of a case where a scan range is a global scan range and a case where a scan range is a local scan range.

In operation S710, the BS 10 may receive information about an RIS ID from the RCU 20. The RIS ID is an identifier indicating an RIS to be used by the RCU 20. The RCU 20 may determine the RIS to be used according to a beam purpose and may identify an RIS ID corresponding to the RIS.

In operation S715, the BS 10 may identify an angle of incidence.

The angle of incidence is an angle formed by a beam transmitted from the BS 10 with the RIS and refers to an angle of departure (AoD). In an embodiment of the present disclosure, the angle of incidence may correspond to the RIS ID. When the BS 10 and the RIS are fixed, the BS receiving the information about the RIS ID may identify the angle of incidence.

In operation S720, the BS 10 may transmit information about the angle of incidence to the RCU 20. In detail, the BS 10 may transmit information about the angle of incidence identified in operation S715. In an embodiment of the present disclosure, information about the angle of incidence may be transmitted together with beam-related information.

In operation S725, the BS 10 may determine beam-related information including an indicator indicating that reflection to an entire area is supported. Hereinafter, search for the entire area is referred to as a global scan for convenience of explanation.

A global scan range may be determined according to capability of the RIS. The capability of the RIS may include hardware characteristics of the RIS and the number of phase shift bits. The hardware characteristics of the RIS may include at least one of a size of the RIS, an RIS unit cell pattern, an RIS unit cell phase error, specular reflection loss, or unit cell reflection loss. In an embodiment of the present disclosure, it may be checked whether there is a UE in a shadow area through the global scan.

In an embodiment of the present disclosure, the global scan range may be indicated through angle information or a flag signal. For example, the global scan range may be indicated through angle information such as a minimum angle of reflection (θ_{t,min}) to a maximum angle of reflection (θ_{t,max}) (e.g. −60° to 60°) according to the capability of the RIS. When the RCU 20 knows the global scan range of the RIS in advance, the global scan range may be indicated in the form of a flag signal (e.g. Global scan mode=1).

The beam-related information may include beam operation information. In an embodiment of the present disclosure, the beam operation information may include at least one of the number of beams to be operated, a beam width, or a beam spacing. The beam-related information may be determined based on the identified angle of incidence.

In operation S730, the BS 10 may transmit the beam-related information including the indicator indicating that reflection to the entire area is supported to the RCU 20. In detail, the BS 10 may transmit the beam-related information including the indicator indicating that the global scan is supported determined in operation S725. In an embodiment of the present disclosure, the angle of incidence identified in operation S715 may be transmitted together with the beam-related information to the RCU 20.

In operation S735, the RCU 20 may generate a first beam book. The first beam book is a beam book for scanning the entire area generated based on the beam-related information including the indicator indicating that the global scan is supported and the identified angle of incidence.

The first beam book generated in the RCU 20 may reflect the hardware characteristics of the RIS. For example, the hardware characteristics of the RIS may include at least one of a size of the RIS, an RIS unit cell pattern, an RIS unit cell phase error, specular reflection loss, or unit cell reflection loss.

In operation S740, RIS beam sweeping may be performed based on the first beam book. The RIS beam sweeping refers to a method of covering the entire area by changing a beam through beamforming using a plurality of antennas. This is a method for solving the problem of narrow cell coverage of a high-frequency band by using the plurality of antennas. A beam may be transmitted to the entire area to be scanned by using a plurality of beams through the beam sweeping.

In operation S745, the RCU 20 may report a result of the RIS beam sweeping to the BS 10. The RCU 20 may report a result of the RIS beam sweeping performed based on the first beam book to the BS 10.

In an embodiment of the present disclosure, when the beam sweeping is performed on the entire area based on the first beam book, the RCU 20 receiving a beam may receive a response from a UE. The response from the UE may include information about a received signal strength. The RCU 20 may report to the BS 10 that the UE is located in the entire area. In an embodiment of the present disclosure, when there are a plurality of UEs in the entire area, the RCU 20 may report information about a beam with a largest received signal strength or a beam with a received signal strength equal to or greater than a certain value.

In operation S750, the BS 10 may determine beam-related information including an indicator indicating that reflection to a specific area is supported. Hereinafter, search for the specific area is referred to as a local scan for convenience of explanation.

A local scan range may refer to a surrounding area based on a beam with a large received signal strength, based on the result received in operation S745. For example, when there are a plurality of UEs in the entire area, a local scan range may be determined based on 3 beams with large received signal strengths from among a plurality of beams.

In an embodiment of the present disclosure, the local scan range may be indicated through angle information or a flag signal. For example, the local scan range may be indicated through angle information of −10° to 10° based on a beam with a largest received signal strength. When the RCU 20 sets a reference signal for scanning a narrow area, the local scan range may be indicated in the form of a flag signal (e.g. −10° to 10°=4).

The beam-related information may include beam operation information. In an embodiment of the present disclosure, the beam operation information may include at least one of the number of beams to be operated, a beam width, or a beam spacing. The beam-related information may be determined based on the identified angle of incidence. In an embodiment of the present disclosure, when there are a plurality of local scan ranges, the BS 10 may determine operation information for each scan range.

In operation S755, the BS 10 may transmit the beam-related information including the indicator indicating that reflection to the specific area is supported to the RCU 20. In detail, the BS 10 may transmit the beam-related information including the indicator indicating that the local scan is supported determined in operation S750. When there are a plurality of local scan ranges, the indicator indicating that the local scan is supported may be transmitted together with operation information determined corresponding to each local scan range.

In operation S760, the RCU 20 may generate a second beam book. The second beam book is a beam book for scanning the specific area generated based on the beam-related information including the local scan range indicator and the identified angle of incidence.

The second beam book generated in the RCU 20 may reflect the hardware characteristics of the RIS. For example, the hardware characteristics of the RIS may include at least one of a size of the RIS, an RIS unit cell pattern, an RIS unit cell phase error, or a unit cell reflection loss. In an embodiment of the present disclosure, when a plurality of local scan ranges to be searched by the BS 10 are set, a plurality of beam books for the plurality of local scan ranges may be generated.

In operation S765, the RIS may be controlled based on the second beam book. The BS 10 and the RCU 20 may transmit and receive a signal for controlling the RIS, and the RCU 20 may transmit the signal for controlling the RIS based on the obtained beam book. The RCU 20 may perform effective RIS control through the beam book generated by reflecting the hardware characteristics of the RIS.

FIG. 8 is a diagram for describing a beam transmission path using an RIS, according to an embodiment.

Referring to FIG. 8, a beam transmitted from the BS 10 is reflected by the RIS 40 and transmitted to the UE 30. In an embodiment of the present disclosure, there may be M elements in the RIS 40. Hereinafter, for convenience of explanation, a beam reflected by an m^{th} element 810 will be mainly described.

In the case of beamforming using the RIS, there are two paths, that is, a first path from the BS 10 to the RIS 40 and a second path from the RIS 40 to the UE 30. In the first path, an angle (θᵣ) formed by a beam transmitted from the BS 10 with the RIS 40 is an angle of departure (AoD) and is referred to as an angle of incidence. In the second path, an angle (θᵢ) formed by a beam reflected by the RIS 40 with the UE 30 is an angle of arrival (AoA) and is referred to as an angle of reflection. As there are a plurality of (M) RIS elements, a phase difference between angles of incidence may be obtained from Equation 1 and a phase difference between angles of reflection may be obtained from Equation 2.

$$ϕ \text{?} = exp ( - j 2 π ( m - 1 ) d cos \text{?} / λ ) \qquad ( 1 )$$

$${ϕ}_{m} \text{?} = exp ( - \frac{\text{?} ( m - 1 ) d cos \text{?}}{\text{?}} ) \qquad ( 2 )$$

$$\text{?} \text{indicates text missing or illegible when filed}$$

In an embodiment of the present disclosure, a beam spacing according to the presence of the M RIS elements is referred to as d 840. In an embodiment of the present disclosure, the beam spacing d 840 may be set to be uniform, or may be set to be non-uniform by the BS 10. M phases may be generated according to the M RIS elements, and b including the M phases may be generated. b=|bᵢ, bᵢ, . . . b_{M}]^{T}, and bₘ denotes a phase for the m^{th} element 810. During transmission to the UE, a beam book b^{(opt)} including information an RIS beam with least data loss may be determined for each of the M phases.

$$\text{?} = exp ( - j 2 \text{?} ( m - 1 ) d ( cos \text{?} + cos \text{?} / λ ) m = \text{?} \qquad ( 3 )$$

$$\text{?} \text{indicates text missing or illegible when filed}$$

According to Equation 3, a most efficient RIS beam

$$( \text{?} )$$

$$\text{?} \text{indicates text missing or illegible when filed}$$

for the m^{th} element 810 may be determined. According to Equation 3, a most efficient RIS beam may be determined by considering an angle of incidence, an angle of reflection, a scan range, the number of RIS beams, a beam width, and a beam spacing.

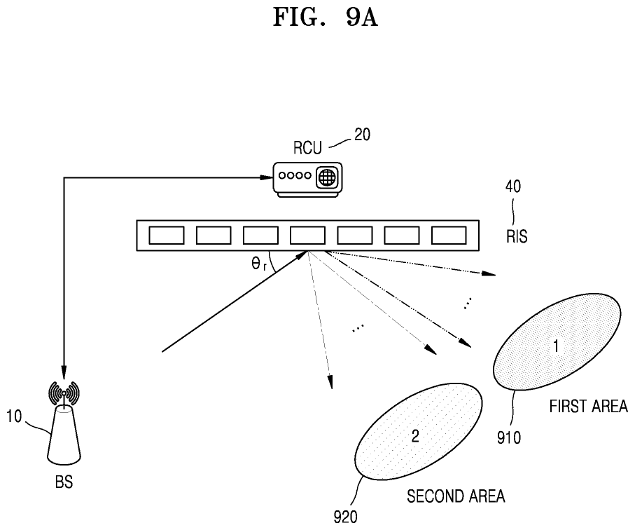

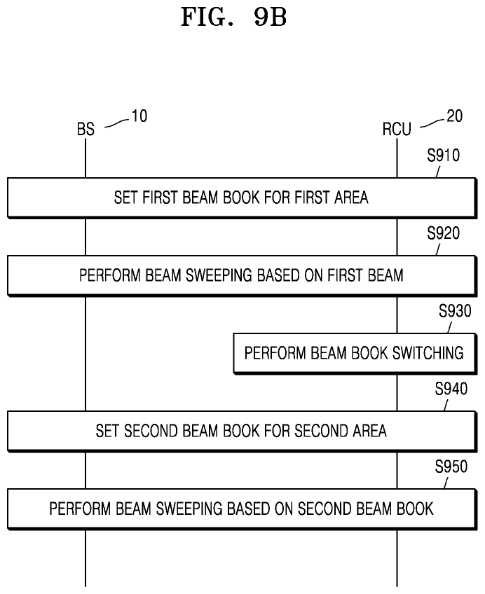

FIGS. 9A and 9B are respectively a diagram and a flowchart for describing a system that supports multiple areas by using a beam book, according to an embodiment.

Referring to FIG. 9A, a wireless communication system for performing a beam transmission method using an RIS according to an embodiment may scan a plurality of areas. The BS 10 and the RCU 20 may perform a procedure of obtaining a beam book for each of the plurality of areas.

When the wireless communication system includes one BS 10 and one RCU 20, an angle of incidence (θᵣ) between the BS 10 and the RCU 20 may be identically identified for the plurality of areas, but beam-related information may be differently determined according to an operation purpose of the BS 10. In an embodiment of the present disclosure, a first area 910 may be a case where a scan is required for a specific area including a first UE in an entire area that may be scanned by considering capability of an RIS. For the first area, a procedure of obtaining a first beam book may be performed on the area including the first UE by using a local scan range described above. For a second area 920, when a scan is required for a specific area including a second UE, a second beam book may be obtained by using a local scan range for the area including the second UE. The BS may control the RIS by using the first beam book or the second beam book according to a target to be searched.

In an embodiment of the present disclosure, the BS 10 may have mobility. When the BS 10 has mobility, an angle of incidence (θᵣ) is variable, and information about the angle of incidence may be obtained through estimation. As the angle of incidence changes, a scan area through reflection of a beam may change.

In an embodiment of the present disclosure, the RIS 40 may have mobility or rotationality. When the RIS 40 has mobility or rotationality, even though a beam is received from the BS 10 that is fixed, the angle of incidence (θᵣ) may change. As the angle of incidence changes, a scan range through reflection of a beam may change.

In an embodiment of the present disclosure, the BS 10 may have mobility, and the RIS 40 may have mobility or rotationality. When locations of both the BS 10 and the RIS 40 change, the angle of incidence (θᵣ) is variable, and thus, a scan range may also change.

Referring to FIG. 9B, when a scan is required for a plurality of areas, the BS 10 may perform search for another shadow area by changing a beam book through beam book switching.

In operation S910, the BS 10 and the RCU 20 may set a first beam book for a first area 910. A process of obtaining a beam book is the same as that described with reference to FIGS. 2 to 7. When the BS 10 is to perform beam sweeping on the first area 910 based on the obtained first beam book, the BS 10 and the RCU 20 may set the first beam book to control an RIS.

In an embodiment of the present disclosure, the first area 910 may be an entire area that is scanned by using a global scan range to check whether there is a UE in a shadow area. In an embodiment of the present disclosure, the first area 910 may be a specific area that is scanned by using a local scan range including a specific UE.

In operation S920, the BS 10 and the RCU 20 may perform beam sweeping based on the first beam book. The beam sweeping refers to a method of covering the entire area by changing a beam through beamforming using a plurality of antennas. This is a method for solving the problem of narrow cell coverage of a high-frequency band by using the plurality of antennas. The BS 10 and the RCU 20 may perform beam sweeping by adjusting a beam spacing, a beam width, and a scan range based on the first beam book.

In an embodiment of the present disclosure, when the first beam book is obtained based on a global scan range, the RCU 20 may report a beam sweeping result to the BS 10. As the beam sweeping result, the RCU 20 may report a beam or candidate beams with highest RSRP to the BS 10 and may determine a local scan range.

In operation S930, the RCU 20 may perform beam book switching. When it is determined that the beam sweeping on the first area 910 is completed, the RCU 20 may obtain a second beam book for a second area 920 and may perform beam switching from the first beam book to the second beam book. In an embodiment of the present disclosure, when a response signal is received from a UE, the RCU 20 may determine that the beam sweeping is completed. In an embodiment of the present disclosure, when reflection of all beams is performed based on the first beam book, the RCU 20 may determine that the beam sweeping is completed.

In an embodiment of the present disclosure, the RCU 20 may determine a shadow area to be searched according to an operation purpose of the BS 10 and may determine a beam book based on a scan range and operation information.

In operation S940, the BS 10 and the RCU 20 may set the second beam book for the second area 920. A process of obtaining the second beam book is the same as that described with reference to FIGS. 2 to 7. When the BS 10 is to perform beam sweeping on the second area 920 based on the obtained second beam book, the BS 10 and the RCU 20 may set the second beam book to control the RIS.

In an embodiment of the present disclosure, when the beam book for the first area 910 is obtained based on a global scan range, the second beam book for the second area 920 may be obtained based on a local scan range. The BS 10 receiving a beam report according to the beam sweeping based on the first beam book may obtain the second beam book for a sharp area based on a beam with high RSRP. A specific process of obtaining a beam according to a scan range is the same as that described with reference to FIG. 7.

In operation S950, the BS 10 and the RCU 20 may perform beam sweeping based on the second beam book. The beam sweeping refers to a method of covering a desired area by changing a beam through beamforming using a plurality of antennas. The BS 10 and the RCU 20 may perform beam sweeping according to a beam spacing, a beam width, and a scan range for the specific area based on the second beam book.

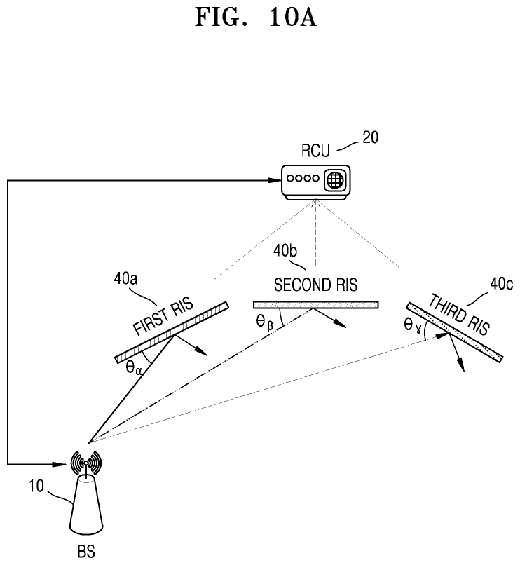

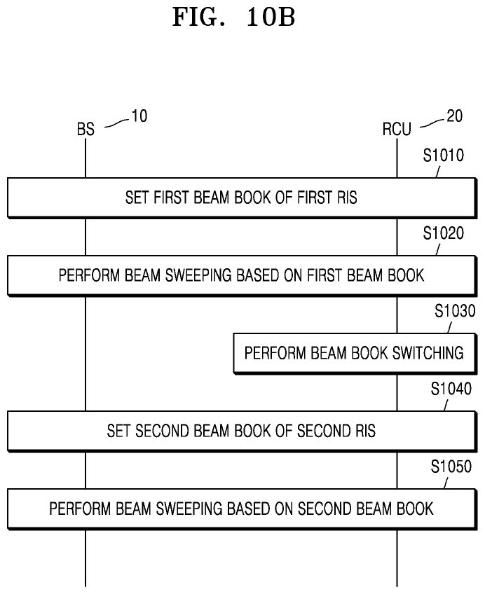

FIGS. 10A and 10B are respectively a diagram and a flowchart for describing a system using a plurality of RISs, according to an embodiment.

Referring to FIG. 10A, a wireless communication system for performing a beam transmission method using an RIS according to an embodiment may use a plurality of RISs. The BS 10 and the RCU 20 may perform a procedure of obtaining a beam book for each RIS to control the plurality of RISs.

When there are a plurality of RISs 40a, 40b, and 40c, angles of incidence formed with the BS 10 may be respectively θᵣ, θ_{B}, and θ_{V} which are different from each other. When each angle of incidence is identified, the BS 10 may determine beam-related information for each RIS according to an operation purpose. The BS 10 may obtain a beam book for each of the RISs 40a, 40b, and 40c based on the identified angle of incidence and the determined beam-related information. A process of obtaining a beam book is the same as that described with reference to FIGS. 2 to 7.

The BS 10 may differently set an operation purpose for each of the RISs 40a, 40b, and 40c. In an embodiment of the present disclosure, the BS 10 may obtain a beam book for scanning an entire area for one RIS, and may obtain a beam book for scanning a specific area for another RIS. In an embodiment of the present disclosure, the BS 10 may obtain a plurality of beam books to scan a plurality of areas for one RIS.

Referring to FIG. 10B, when a beam transmission method is performed by using a plurality of RISs, the BS 10 may perform the beam transmission method by determining an RIS to be used.

In operation S1010, the BS 10 and the RIS 20 may set a first beam book of a first RIS. A process of obtaining the first beam book of the first RIS is the same as that described with reference to FIGS. 2 to 7. When the BS 10 is to control the first RIS based on the obtained first beam book, the BS 10 and the RCU 20 may set the first beam book.

In an embodiment of the present disclosure, when there a plurality of RISs, an RIS ID may be used to identify each RIS. In detail, the RCU 20 may determine an RIS to be used according to an operation purpose of the BS 10 and may identify an ID corresponding to the RIS. The RCU 20 may transmit the identified RIS ID to the BS 10. The BS 10 and the RCU 20 may set a beam book based on the identified RIS ID.

In an embodiment of the present disclosure, the BS 10 and the RCU 20 may generate a plurality of beam books according to an operation purpose for one RIS. The BS 10 and the RCU 20 may determine an RSC to be used from among a plurality of RISs according to a system operation purpose and may set a beam book suitable for an operation purpose from among a plurality of beam books in the determined RIS.

In operation S1020, the BS 10 and the RCU 20 may perform beam sweeping based on the first beam book. The beam sweeping refers to a method of covering an entire area by changing a beam through beamforming using a plurality of antennas. This is a method for solving the problem of narrow cell coverage of a high-frequency band by using the plurality of antennas. The BS 10 and the RCU 20 may perform beam sweeping by controlling the RIS according to a beam spacing, a beam width, and a scan range based on the first beam book.

In operation S 1030, the RCU 20 may perform beam book switching. When it is determined that the beam sweeping based on the first beam book is completed, the RCU 20 may change to a second beam book of a second RIS. In an embodiment of the present disclosure, when the RCU 20 receives a response to a signal received from a UE, the RCU 20 may determine that the beam sweeping is completed. In an embodiment of the present disclosure, when reflection of all beams is performed based on the first beam book, the RCU 20 may determine that the beam sweeping is completed.

In an embodiment of the present disclosure, the RCU 20 may determine an RIS to be used according to the operation purpose of the BS 10 and may determine a beam book based on a scan range and operation information in the RIS.

In operation S1040, the BS 10 and the RCU 20 may set the second beam book of the second RIS. A process of obtaining the second beam book of the second RIS is the same as that described with reference to FIGS. 2 to 7. When the BS 10 is to control the second RIS based on the obtained second beam book, the BS 10 and the RCU 20 may set the second beam book.

In operation S1050, the BS 10 and the RCU 20 may perform beam sweeping based on the second beam book. The beam sweeping refers to a method of covering a desired area by changing a beam through beamforming using a plurality of antennas. The BS 10 and the RCU 20 may perform beam sweeping by controlling the second RIS according to a beam spacing, a beam width, and a scan range based on the second beam book.

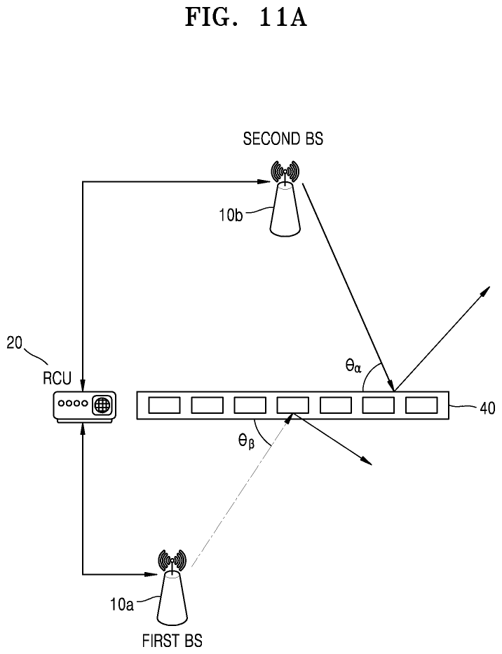

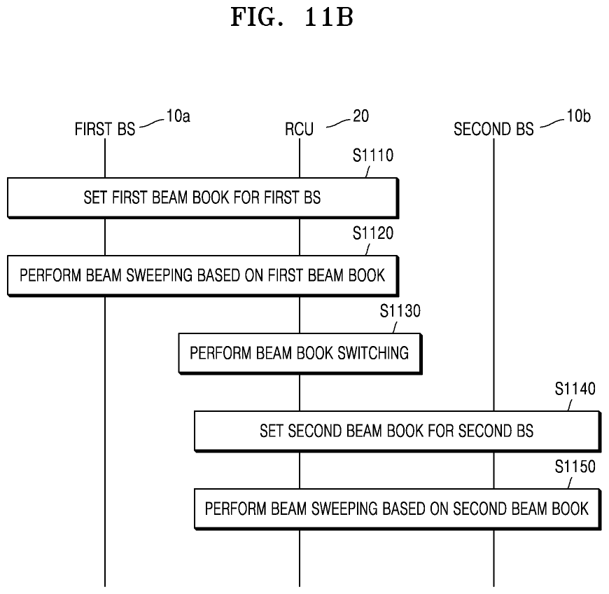

FIGS. 11A and 11B are respectively a diagram and a flowchart for describing a system using a plurality of BSs, according to an embodiment.

Referring to FIG. 11A, a wireless communication system for performing a beam transmission method using an RIS according to an embodiment may include a plurality of BSs. Each of a plurality of BSs (e.g., 10a and 10b) may obtain a beam book for controlling the RIS 40.

When there are the plurality of BSs (e.g., 10a and 10b), angles of incidence between the BS and the RIS may be different. When each angle of incidence is identified, each of the BSs (e.g., 10a and 10b) may determine beam-related information according to an operation purpose. Each of the BSs (e.g., 10a and 10b) may transmit and receive a control signal to and from the RCU 20 to control the RIS.

Operation purposes of the plurality of BSs (e.g., 10a and 10b) may be different from each other. In an embodiment of the present disclosure, a first BS 10a may have a purpose of scanning an entire area, and a second BS 10b may have a purpose of scanning a specific area.

In an embodiment of the present disclosure, the BSs (e.g., 10a and 10b) may obtain a plurality of beam books to scan a plurality of areas according to operation purposes for one RIS 40. In an embodiment of the present disclosure, the BSs (e.g., 10a and 10b) may perform a beam transmission method by sharing a plurality of RISs 40. Each BS may obtain a beam book for each of the plurality of RISs 40.

Referring to FIG. 11B, when a beam transmission method is performed by using a plurality of BSs, an RCU may perform beam setting for each BS.

In operation S1110, the first BS 10a and the RCU 20 may set a first beam book for the first BS 10a. A process of obtaining the first beam book is the same as that described with reference to FIGS. 2 to 7. When an RIS is to be controlled based on the obtained first beam book, the BS 10 and the RCU 20 may set the first beam book.

In operation S1120, the first BS 10a and the RCU 20 may perform beam sweeping based on the first beam book. The beam sweeping refers to a method of covering an entire area by changing a beam through beamforming using a plurality of antennas. The beam sweeping is a method for solving the problem of narrow cell coverage of a high-frequency band by using the plurality of antennas. The first BS 10a and the RCU 20 may perform beam sweeping by controlling the RIS according to a beam spacing, a beam width, and a scan range based on the first beam book.

In an embodiment of the present disclosure, the first BS 10a may obtain a plurality of beam books to scan a plurality of areas. The first BS 10a may obtain a plurality of beam books according to beam transmission using a plurality of RISs. The first BS 10a may determine a beam book to be used from among the plurality of beam books according to a system operation purpose.

In operation S1130, the RCU 20 may perform beam book switching. When it is determined that the beam sweeping based on the first beam book is completed, the RCU 20 may change to a second beam book for the second BS 10b. In an embodiment of the present disclosure, when the RCU 20 receives a response signal from a UE, the RCU 20 may determine that the beam sweeping is completed. In an embodiment of the present disclosure, when reflection of all beams is performed based on the first beam book, the RCU 20 may determine that the beam sweeping is completed.

In an embodiment of the present disclosure, the RCU 20 may receive a signal for RIS control from the BS 10b and may perform beam switching. In an embodiment of the present disclosure, when there are a plurality of RISs, the RCU 20 may determine an RIS to be used according to an operation purpose of the second BS 10b and may determine a beam book according to a scan range and operation information in the RIS.

In operation S1140, the second BS 10b and the RCU 20 may set the second beam book for the second BS 10b. A process of obtaining the second beam book is the same as that described with reference to FIGS. 2 to 7. When the second BS 10b is to control the RIS, the second BS 10b and the RCU 20 may set the second beam book.

In operation S1150, the second BS 10b and the RCU 20 may perform beam sweeping based on the first beam book. The beam sweeping refers to a method of covering a desired area by changing a beam through beamforming using a plurality of antennas. The second BS 10b may perform beam sweeping by controlling the RIS according to a beam spacing, a beam width, and a scan range, based on the obtained second beam book.

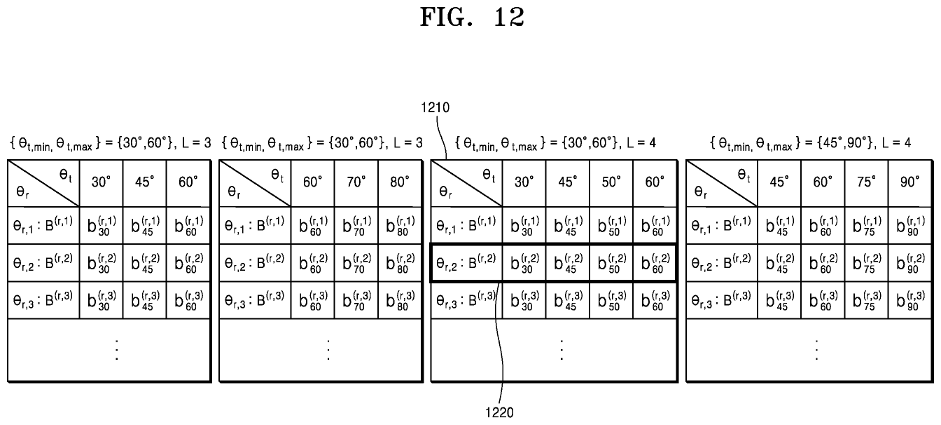

FIG. 12 is a diagram for describing an example of a pre-determined beam book, according to an embodiment.

Referring to FIG. 12, the BS 10 and the RCU 20 may use a pre-determined beam book to control the RIS 40. The BS 10 may receive an RIS ID corresponding to the RIS 40 to be used from the RCU 20. The RCU 20 may identify an RIS to be used according to a beam purpose and may identify an RIS ID corresponding to the RIS.

The BS 10 may identify an angle of incidence, which is an angle between a beam transmitted from the BS 10 and the RIS. In an embodiment of the present disclosure, the BS 10 or the RIS 40 may have mobility or rotationality. The angle of incidence is variable according to mobility or rotationality. In order to estimate the variable angle of incidence, the angle of incidence may be identified by using a channel estimated through a CSI-RS. Also, the angle of incidence may be identified by measuring received power through beam sweeping or may be identified by using an AOA estimation algorithm.

The BS 10 may determine beam-related information according to an operation purpose. The beam-related information may include a scan range, the number of beams, a beam width, or a beam spacing. The BS 10 may determine an index of a preset beam book based on the identified angle of incidence and determined operation information.

In an embodiment of the present disclosure, in the beam-related information, when the scan range of the operation information is 30° to 60° and the number of beams is 4, a candidate table 1210 may be determined in the beam book. When the angle of incidence identified by the BS 10 is θᵣ, a block 1220 may be selected. According to the block 1220, a most efficient RIS beam (e.g., b₃₀^{(r,2)}, b₄₀^{(r,2)}, b₅₀^{(r,2)}, b₆₀^{(r,2)}) corresponding to the scan range may be determined and may be reflected to a UE. In an embodiment of the present disclosure, the BS 10 may determine a most efficient RIS beam in the beam book by using the determined index of the beam book. In an embodiment of the present disclosure, the BS 10 may transmit the identified angle of incidence and the determined operation information to the RCU 20. The RCU 20 may determine a most efficient RIS beam in the preset beam book based on the received information.

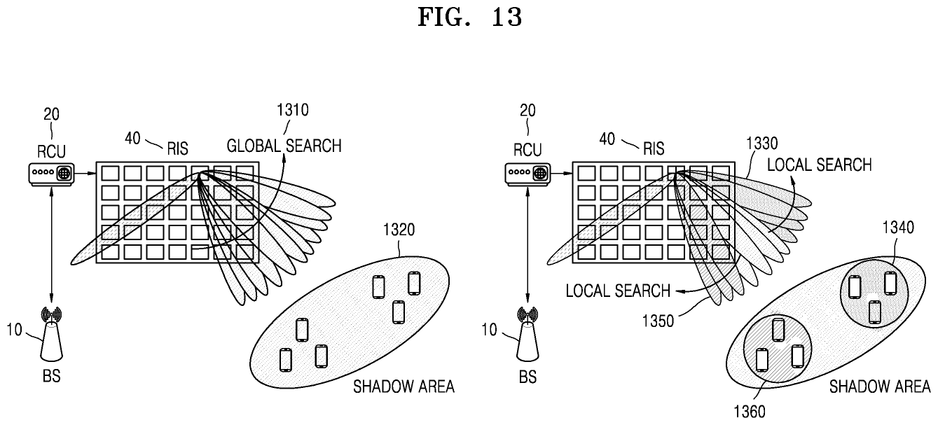

FIG. 13 is a diagram for describing a scan range, according to an embodiment.

Referring to FIG. 13, the BS 10 may determine a scan range by using a transmitted beam. The scan range may be determined according to capability of an RIS. The capability of the RIS may include hardware characteristics of the RIS, the number of phase shift bits, etc. An entire area that may be scanned according to the capability of the RIS is referred to as a global scan range. When only a specific area is scanned according to a beam purpose in the global scan range, the specific area is referred to as a local scan range.

In an embodiment of the present disclosure, a beam may perform a scan 1310 for a shadow area 1320 according to the capability of the RIS 40. A global scan may be to check whether there is a UE in the area. The scan range may be indicated by using angle information or a flag signal. There may be a plurality of UEs in the shadow area 1320 according to the global scan range.

In an embodiment of the present disclosure, a beam may perform scans 1330 and 1350 for specific areas 1340 and 1360 according to a beam operation purpose. A local scan may be to scan only a specific area where a UE exists and obtain information. The scan range may be indicated by using angle information or a flag signal.

In an embodiment of the present disclosure, the BS 10 and the RCU 20 may obtain a first beam book by using a global scan range and may perform beam sweeping based on the obtained first beam book. The BS 10 may receive a report regarding a result of the beam sweeping from the RCU 20. Based on the report, the BS 10 may determine a local scan range for a surrounding area based on a beam with highest RSRP. Alternatively, the BS 10 and the RCU 20 may determine a plurality of local scan ranges for a surrounding area based on a plurality of beams with RSRP equal to or greater than a certain value. The BS 10 and the RCU 20 may obtain a second beam book using a local scan range and may perform beam sweeping based on the obtained second beam book. A specific process is the same as that described with reference to FIG. 7.

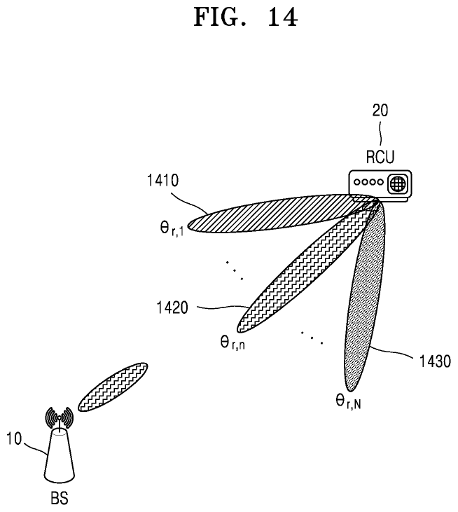

FIG. 14 is a diagram for describing a method of estimating an angle of incidence, according to an embodiment.

Referring to FIG. 14, when an angle of incidence is variable, the BS 10 and the RCU 20 may estimate and identify the angle of incidence.

In an embodiment of the present disclosure, the angle of incidence may be estimated by using a channel state information reference signal (CSI-RS). A channel h may be estimated as shown in Equation 4 by using a CSI-RS transmitted from the BS 10 to the RCU 20.

$$\text{?} = h = [ \begin{matrix}{h}_{1} & {h}_{2} & \begin{matrix}… & {h}_{M} \text{?} = \text{?}\end{matrix}\end{matrix} \qquad ( 4 )$$

$$\text{?} \text{indicates text missing or illegible when filed}$$

A phase difference Δφ between adjacent antennas may be obtained from the estimated channel h. An angle of incidence θᵣ may be obtained from Equation 5 by using the phase difference Δφ between adjacent antennas.

$$Δ ϕ = \frac{- 2 π d cos \text{?}}{λ} \text{?} = {cos}^{- 1} \frac{Δ ϕ \cdot λ}{- 2 π d} \qquad ( 5 )$$

$$\text{?} \text{indicates text missing or illegible when filed}$$

The RCU 20 may transmit the estimated angle of incidence itself to the BS 10 or may transmit channel information for estimating the angle of incidence to the BS 10. The BS 10 may identify the angle of incidence θᵣ based on the received channel information.

In an embodiment of the present disclosure, the estimation of the angle of incidence may be performed by using beam sweeping. The BS 10 may measure RSRP through beam sweeping to the RCU 20 and may use the RSRP to estimate the angle of incidence. In an embodiment of the present disclosure, the BS 10 may emit N beams to estimate the angle of incidence θᵣ. The RCU may measure RSRP for each of N beams 1410, 1420, and 1430 and may transmit a report regarding the RSRP to the BS 10. The BS 10 may estimate an angle for the beam 1420 with highest RSRP from among the plurality of beams according to the received report as the angle of incidence θᵣ. In an embodiment of the present disclosure, the RCU 20 may transmit the angle of incidence itself according to the beam 1420 with highest RSRP to the BS 10 or may transmit RSRP values for the plurality of beams or information about the beam 1420 with a highest RSRP value. The BS 10 may identify the angle of incidence θᵣ based on the received RSRP-related information.

In an embodiment of the present disclosure, the angle of incidence may be estimated by using an AOA estimation algorithm through multi-antennal processing. A multiple signal classification (MUSIC) algorithm is an algorithm for estimating maximum power and a direction of arrival (DOA) of a received signal by using a covariance matrix of the received signal obtained from an array antenna. For a beam transmitted from the BS, the RCU 20 may obtain maximum power of a received signal and may estimate an angle of incidence. In an embodiment of the present disclosure, the RCU 20 may transmit the estimated angle of incidence to the BS 10 and may receive information about the maximum power of the received signal. Compared to the MUSIC algorithm, an estimation of signal parameters via rotational invariance techniques (ESPRIT) algorithm is a DOA estimation algorithm having geometrical limitations but computational advantages. The ESPRIT algorithm may estimate a frequency and a DOA by determining parameters of a mixture of sinusoids in background noise. In an embodiment of the present disclosure, the RCU 20 may transmit the angle of incidence θᵣ itself to the BS 10 or may transmit information for estimating the angle of incidence. The BS 10 may identify the angle of incidence based on the received information.

In an embodiment of the present disclosure, the BS 10 may set an angle of incidence estimation period. The BS 10 may differently set an angle of incidence estimation period according to a system operation purpose. For example, when frequent updates of information are required for a sharp area, the BS 10 perform angle of incidence estimation in a short cycle. In an embodiment of the present disclosure, when the BS 10 or an RIS has mobility or rotationality, the BS 10 may set an angle of incidence estimation period by considering a moving speed or rotation periodicity. For example, when a rotation period is constant at w, the BS 10 may set the same angle of incidence estimation period and may adjust an angle of incidence error due to signal distortion. In an embodiment of the present disclosure, when the angle of incidence is estimated by using a CSI-RS, the BS may set an angle of incidence estimation period by considering periodicity of a channel. For example, the period of the channel and the angle of incidence estimation period may be set to be the same.

Referring to FIG. 15, a BS 1500 may include a processor 1510, a transceiver 1520, and a memory (not shown). The transceiver 1520, the processor 1510, and the memory of the BS 1500 may operate according to a communication method of the BS 1500 described above. However, elements of the BS 1500 are not limited thereto. For example, the BS 1500 may include more or fewer elements than those described above. In an embodiment of the present disclosure, the transceiver 1520, the processor 1510, and the memory may be implemented as a single chip. Furthermore, the processor 1510 may include one or more processors.

The processor 1510 may control a series of processes so that the BS 1500 operates according to an embodiment of the present disclosure described above. For example, the processor 1510 may receive a control signal and a data signal through the transceiver 1520 and may process the received control signal and data signal. The processor 1510 may transmit the processed control signal and data signal through the transceiver 1520. Also, the processor 1510 may write and read data to and from the memory. Also, the processor 1510 may perform functions of a protocol stack required by communication standards. To this end, the processor 1510 may include at least one processor or micro processor. In an embodiment of the present disclosure, a part of the transceiver 1520 or the processor 1510 may be referred to as a communication processor (CP).

The processor 1510 may include one or more processors. In this case, the one or more processors may include a central processing unit (CPU), an application processor (AP), or a digital signal processor.

A receiver of the BS 1500 and a transmitter of the BS 1500 are collectively referred to as the transceiver 1520, which may transmit and receive signals to and from a UE, an RCU, or a network entity. In this regard, the signals being transmitted and received to and from the UE, the RCU or the network entity may include control information and data. To this end, the transceiver 1520 may include an RF transmitter for up-converting and amplifying a frequency of a transmitted signal, and an RF receiver for low-noise amplifying and down-converting a frequency of a received signal. However, this is only an example of the transceiver 1520, and elements of the transceiver 1520 are not limited to the RF transmitter and the RF receiver.

Also, the transceiver 1520 may perform functions for transmitting and receiving a signal via a wireless channel. For example, the transceiver 1520 may receive a signal through a wireless channel and output the signal to the processor 1510, and may transmit a signal output from the processor 1510 through the wireless channel.

The memory may store a program and data required to operate the BS 1500. Furthermore, the memory may store control information or data included in a signal obtained by the BS. The memory may include a storage medium such as a read-only memory (ROM), a random-access memory (RAM), a hard disk, compact disc (CD)-ROM, or a digital versatile disc (DVD), or any combination thereof. In addition, the memory may not exist separately but may be included in the processor 1510. The memory may include a volatile memory, a nonvolatile memory, or a combination of a volatile memory and a nonvolatile memory. The memory may provide stored data according to a request of the processor 1510.

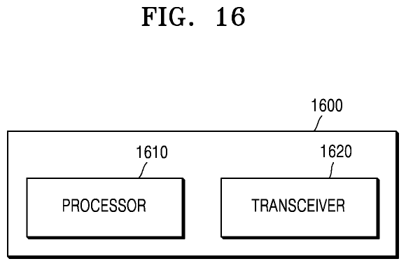

FIG. 16 is a block diagram schematically illustrating a configuration of an RCU, according to an embodiment.

Referring to FIG. 16, an RCU 1600 according to the present disclosure may include a processor 1610, a transceiver 1620, and a memory (not shown). However, elements of the RCU 1600 are not limited thereto. For example, the RCU 1600 may include more or fewer elements than those described above. In an embodiment of the present disclosure, the processor 1610, the memory, and the transceiver 1620 may be implemented as a single chip.

The processor 1610 may include one or more processors. In this case, the one or more processors may include a CPU, an AP, or a digital signal processor (DSP).

The processor 1610 may control a series of processes so that the RCU 1600 operates according to an embodiment of the present disclosure described above. For example, the processor 1610 may receive a control signal and a data signal through the transceiver 1620 and may process the received control signal and data signal. The processor 1610 may transmit the processed control signal and data signal through the transceiver 1620 and may detect an event. Furthermore, the processor 1610 may control input data derived from the received control signal and data signal to be processed according to a predefined operation rule or artificial intelligence (AI) model stored in the memory. The processor 1610 may write and read data to and from the memory. The processor 1610 may perform functions of a protocol stack required by communication standards. According to an embodiment, the processor 1610 may include at least one processor. In an embodiment of the present disclosure, a part of the transceiver 1620 or the processor 1610 may be referred to as a communication processor (CP). The processor 1610 may enable the RCU 1610 to perform RIS control according to an embodiment of the present disclosure described above. The processor 1610 may generate a beam book for controlling the RIS through communication with a BS.

The memory may store a program and data required for operations of the RCU 1600. Also, the memory may store control information or data included in a signal obtained by the RCU 1600. Furthermore, the memory may store the predefined operation rule or the AI model used in the RCU 1600. The memory may include a storage medium such as a ROM, a RAM, a hard disk, a CD-ROM, or a DVD, or any combination thereof. In addition, the memory may not exist separately and may be included in the processor 1610. The memory may include a volatile memory, a nonvolatile memory, or a combination of a volatile memory and a nonvolatile memory. The memory may provide stored data according to a request of the processor 1610.

A transmitter and a receiver re collectively referred to as the transceiver 1620, and the transceiver 1620 of the RCU 1600 may transmit and receive signals to and from a BS or a network entity. The transmitted or received signals may include control information and data. To this end, the transceiver 1620 may include an RF transmitter for up-converting and amplifying a frequency of a transmitted signal, and an RF receiver for low-noise amplifying and down-converting a frequency of a received signal. However, this is only an example of the transceiver 1620, and elements of the transceiver 1620 are not limited to the RF transmitter and the RF receiver. Also, the transceiver 1620 may receive a signal through a wireless channel and output the signal to the processor 1610, and may transmit a signal output from the processor 1610 through the wireless channel. The transceiver 1620 may transmit a signal output from the processor 1610 to the BS to obtain a beam book and may receive a signal from the BS. Also, the transceiver 1620 may transmit a signal through a wireless channel to an RIS to control the RIS based on the obtained beam book.

A machine-readable storage medium may be provided as a non-transitory storage medium. Here, ‘non-transitory’ means that the storage medium does not include a signal (e.g., an electromagnetic wave) and is tangible, but does not distinguish whether data is stored semi-permanently or temporarily in the storage medium. For example, the ‘non-transitory storage medium’ may include a buffer in which data is temporarily stored.

According to an embodiment, methods according to various embodiments of the present disclosure may be provided in a computer program product. The computer program product may be a product purchasable between a seller and a purchaser. The computer program product may be distributed in the form of a machine-readable storage medium (e.g., a compact disc read-only memory (CD-ROM)), or distributed (e.g., downloaded or uploaded) online via an application store or between two user devices (e.g., smartphones) directly. When distributed online, at least part of the computer program product (e.g., a downloadable application) may be temporarily generated or at least temporarily stored in a machine-readable storage medium, such as a memory of a server of a manufacturer, a server of an application store, or a relay server.

In an embodiment of the present disclosure, a method by which a BS performs communication in a wireless communication system may include receiving information about an RIS ID from an RIS control unit (RCU), which is a communication entity that reflects a beam transmitted from the BS and transmits the reflected beam to a user equipment (UE). The method may include identifying an angle of incidence to the RIS from the BS corresponding to the RIS ID, based on the information about the RIS ID. The method may include determining beam-related information used to scan a preset area based on the identified angle of incidence, wherein a beam book for RIS control in the RCU is obtained based on the identified angle of incidence and the determined beam-related information.

In an embodiment of the present disclosure, the method by which the BS performs communication in the wireless communication system may include transmitting a channel state information reference signal (CSI-RS) from the BS to the RCU. The method may further include receiving information related to an angle of incidence estimated by using the CSI-RS, wherein the angle of incidence is identified based on the information related to the angle of incidence estimated by using the CSI-RS.

In an embodiment of the present disclosure, the beam-related information may include information related to a scan range through reflection of the beam by the RIS. Also, the scan range may be indicated through a flag signal or angle information of an angle of reflection of the beam by the RIS.

In an embodiment of the present disclosure, the information related to the scan range may include an indicator indicating that reflection of a beam to an entire scan area is supported by the RIS or an indicator indicating that reflection of a beam to a specific area in the entire area is supported by the RIS, based on capability of the RIS.

In an embodiment of the present disclosure, the method by which the BS performs communication in the wireless communication system may include obtaining a first beam book for scanning the entire area based on the indicator indicating that reflection of a beam to the entire scan area is supported. The method may further include obtaining a second beam book for scanning the specific area based on the indicator indicating that reflection of a beam to the specific area in the entire area is supported.

In an embodiment of the present disclosure, the beam-related information may include information about at least one of the number of beams set by the BS, a width of a beam reflected by the RIS, or a beam spacing.

In an embodiment of the present disclosure, the method by which the BS performs communication in the wireless communication system may further including generating a beam book based on the identified angle of incidence and the determined beam-related information, and transmitting the generated beam book to the RCU.

In an embodiment of the present disclosure, the method by which the BS performs communication in the wireless communication system may further include transmitting the identified angle of incidence and the determined beam-related information to the RCU, wherein the beam book is generated based on the identified angle of incidence and the determined beam-related information in the RCU.

In an embodiment of the present disclosure, the method by which the BS performs communication in the wireless communication system may further include, in case that beam books are obtained respectively for a plurality of RISs controlled by the RCU, setting a beam book for an RIS to be used by the BS from among the beam books for the plurality of RISs.

1. A method by which a base station (BS) performs communication in a wireless communication system, the method comprising:
receiving information about a reconfigurable intelligent surface (RIS) identity (ID) from an RIS control unit (RCU), which is a communication entity that controls an RIS that reflects a beam transmitted from the BS and transmits the reflected beam to a user equipment (UE);
identifying an angle of incidence to the RIS from the BS corresponding to the RIS ID, based on the information about the RIS ID; and
determining beam-related information used to scan a preset area, based on the identified angle of incidence,
wherein a beam book for RIS control in the RCU is obtained based on the identified angle of incidence and the determined beam-related information.

2. The method of claim 1, further comprising:
transmitting a channel state information reference signal (CSI-RS) to the RCU; and
receiving information related to an angle of incidence estimated by using the CSI-RS,
wherein the angle of incidence is identified based on the information related to the angle of incidence estimated by using the CSI-RS.

3. The method of claim 1 or 2, wherein the beam-related information comprises information related to a scan range through reflection of the beam by the RIS,
wherein the scan range is indicated through a flag signal or angle information of an angle of reflection of the beam by the RIS.

4. The method of claim 3, wherein the information related to the scan range comprises
an indicator indicating that reflection of a beam to an entire scan area is supported by the RIS, or
an indicator indicating that reflection of a beam to a specific area in the entire area is supported by the RIS, based on capability of the RIS,
wherein the method further comprises:
obtaining a first beam book for scanning the entire area based on the indicator indicating that reflection of a beam to the entire scan area is supported; and
obtaining a second beam book for scanning the specific area based on the indicator indicating that reflection of a beam to the specific area in the entire area is supported.

5. The method of any one of claims 1 to 4, wherein the beam-related information comprises information about at least one of a number of beams set by the BS, a width of a beam reflected by the RIS, or a beam spacing.

6. The method of any one of claims 1 to 5, further comprising:
generating a beam book based on the identified angle of incidence and the determined beam-related information; and
transmitting the generated beam book to the RCU.

7. The method of any one of claims 1 to 6, further comprising transmitting the identified angle of incidence and the determined beam-related information to the RCU,
wherein the beam book is generated based on the identified angle of incidence and the determined beam-related information in the RCU.

8. The method of any one of claims 1 to 7, further comprising, in case that beam books are obtained respectively for a plurality of RISs controlled by the RCU, setting a beam book for an RIS to be used by the BS from among the beam books for the plurality of RISs.

9. A base station (BS) for performing communication in a wireless communication system, the BS comprising:
a transceiver; and
at least one processor connected to the transceiver and configured to receive information about a reconfigurable intelligent surface (RIS) identity (ID) from an RIS control unit (RCU), which is a communication entity that controls an RIS that reflects a beam transmitted from the BS and transmits the reflected beam to a user equipment (UE),
identify an angle of incidence to the RIS from the BS corresponding to the RIS ID, based on the information about the RIS ID, and
determine beam-related information used to scan a preset area, based on the identified angle of incidence,
wherein a beam book for RIS control in the RCU is obtained based on the identified angle of incidence and the determined beam-related information.

10. The BS of claim 9, wherein the at least one processor is further configured to
transmit a channel state information reference signal (CSI-RS) to the RCU, and
receive information related to an angle of incidence estimated by using the CSI-RS,
wherein the angle of incidence is identified based on the information related to the angle of incidence estimated by using the CSI-RS.

11. The BS of claim 9 or 10, wherein the beam-related information comprises information related to a scan range through reflection of the beam by the RIS,
wherein the scan range is indicated through a flag signal or angle information of an angle of reflection of the beam by the RIS.

12. The BS of any one of claims 9 to 11, wherein the beam-related information comprises information about at least one of a number of beams set by the BS, a width of a beam reflected by the RIS, or a beam spacing.

13. The BS of any one of claims 9 to 12, wherein the at least one processor is further configured to
generate a beam book based on the identified angle of incidence and the determined beam-related information, and
transmit the generated beam book to the RCU.

14. The BS of any one of claims 9 to 13, wherein the at least one processor is further configured to transmit the identified angle of incidence and the determined beam-related information to the RCU,
wherein the beam book is generated based on the identified angle of incidence and the determined beam-related information in the RCU.

15. A computer-readable recording medium having recorded thereon a program for executing the method of any one of claims 1 to 8, on a computer.
